(19) United States
(12) Patent Application Publication
(10) Pub. No.: US 2011/0117536 A1
(43) Pub. Date: May 19, 2011

(54) GAME TABLE POINT OF PURCHASE DISPLAY

(76) Inventors: SCOTT ZELACHOWSKI, Whitehall, PA (US); SCOTT HOFFMAN, Newton, NJ (US); ADAM ABRAMSON, Oxford, NJ (US)

(21) Appl. No.: 12/751,319

(22) Filed: Mar. 31, 2010

(51) Int. Cl. G09B 25/00

(52) U.S. Cl. 434/365

(57) ABSTRACT

A display device having a segment of a functional game table, and display means attached to the segment for providing information about the segment to a viewer is disclosed. The segment of a functional game table may be taken along a longitudinal axis, transverse axis, or other section of the table.

### FIELD OF THE INVENTION

This disclosure relates to point of purchase displays generally and, more specifically, to point of purchase displays for game tables.

### BACKGROUND OF THE INVENTION

Customers generally prefer to be able to see and touch items prior to purchasing. Oftentimes it is difficult to convey the appearance and textures of items through photographs on packaging. Display items are often used to facilitate pre-purchase decision making. When an item is manageably small, the item may simply be placed within view or otherwise made available for handling or viewing. However, display of large items such as game tables may force the retailer into a compromise between the display of available items and the forfeiture of floor space for other items.

In some instances, a retailer may wish to highlight various features and selling points of large item on display for a customer. Packaging may display some of this information, but the packaging may not be readily available for the customer to view. This is particularly so were the decision has been made to actually display a large item itself. The packaged goods may be in a warehouse or otherwise out of view to the customer. Placards and signage may be placed on display items but generally only a limited amount of information can be displayed in this way. Additionally, unless the signage is repeated from every angle, it is not certain that every customer will have the benefit of viewing this information since large items such as game tables may be viewed and used from multiple angles

What is needed is a system and method for addressing the above and related issues.

### SUMMARY OF THE INVENTION

The invention of the present disclosure, in one aspect thereof, comprises a display device having a segment of a functional game table, and display means attached to the segment for providing information about the segment to a viewer. A base may be attached to the segment of a functional game table and the display means may include a surface providing textual information regarding the game table. The display means may include a sample of a portion of the game table. In some embodiments, the segment of a functional game table is taken along a longitudinal axis of the table. In other embodiments, the segment of a functional game table is taken along a transverse axis of the table. The functional game table may be a pool table, a foosball table, a hockey game table, or another game table.

### BRIEF DESCRIPTION OF THE DRAWINGS

FIG. 1 is a perspective view of a point-of-purchase display system according to aspects of the present disclosure.

FIG. 2 is a perspective view of another point-of-purchase display system according to aspects of the present disclosure.

### DETAILED DESCRIPTION OF THE PREFERRED EMBODIMENTS

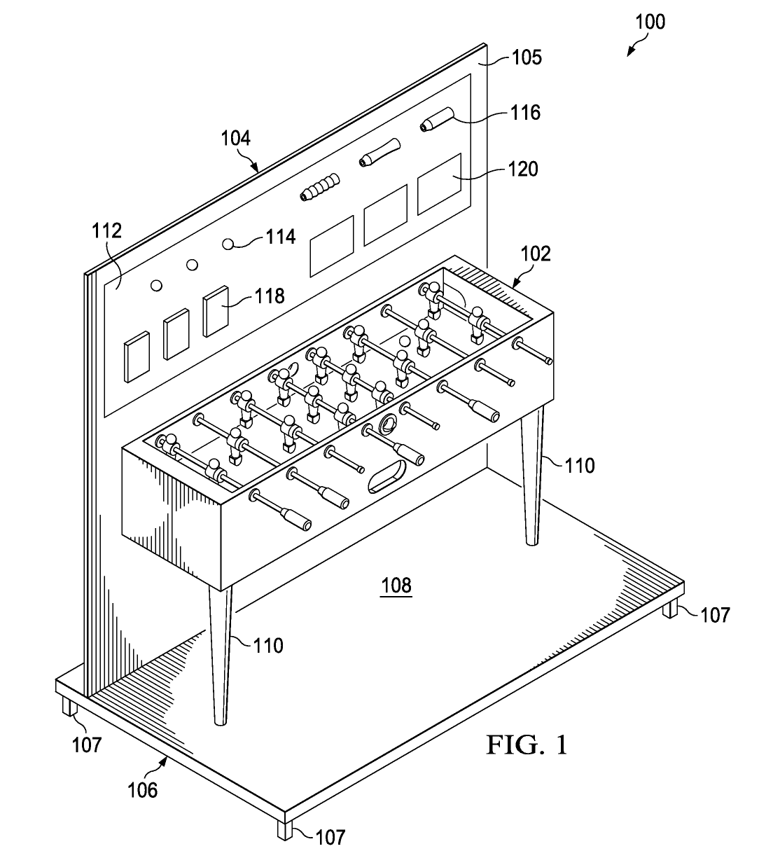

Referring now to FIG. 1, a perspective view of a point-of-purchase display system according to aspects of the present disclosure is shown. The display device 100 generally comprises a portion, segment, or cutaway 102 of a game table. In some embodiments, the segment 102 will be a portion of a full-sized, fully-functioning game table. The game table may be a foosball table as shown in FIG. 1, but it may also be a pool table, an air hockey table, a card table, a bowling table, a tennis table, or another type of game table. In some embodiments, the segment 102 will be fully functioning in that it will feature whatever handles, slides, openings, ball returns, and other equipment are normally associated with the full sized game table. In the present embodiment, the full sized game table is segmented to form the display segment 102. The segment 102 may also be purpose built as half (or another portion) of a game table in order to demonstrate the features and functionality of the game table in a reduced amount of space.

In the present embodiment, the game table segment 102 will be attached to a display device 104. The display device 104 provides information and/or displays equipment samples related to the game table segment 102. In the present embodiment, a base 106 is provided that may attach to the display device 104. In some embodiments, legs 110 associated with the game table segment 102 will also contact the base 106. The base 106 may be decorated with tiles, carpet, or other decorations to reflect a game table environment. In some embodiments, the base 106 provides a horizontal floor surface 108. In some embodiments, the base 106 may be provided with short legs 107 or placed on a forklift pallet for easier transport and placement.

It can be seen that the display device 104 in the present embodiment provides a vertical surface 105 upon which an information area 112 may be provided for viewing. The information area 112 may provide textual information relating to the game table segment 102. This information may include, but is not limited to, information regarding the structure of the segment 102, the materials of its construction, and/or the game and functionality of the display segment 102.

In some embodiments, product samples may also be provided on the information area 112. The samples may include game balls 114, game handle samples 116, and/or wood or other material samples 118. In this way, a customer viewing the display 100 will be able to see and appreciate not only the hardware and features of the display table 102, but also optional or additional hardware that may be available for purchase. As mentioned, textual information may be provided on the display device 104. In addition, photographs or diagrams shown at 120 may also be provided. The diagrams 120 may provide information relating to the structure of the game table 102, rules of game play, and/or other optional features.

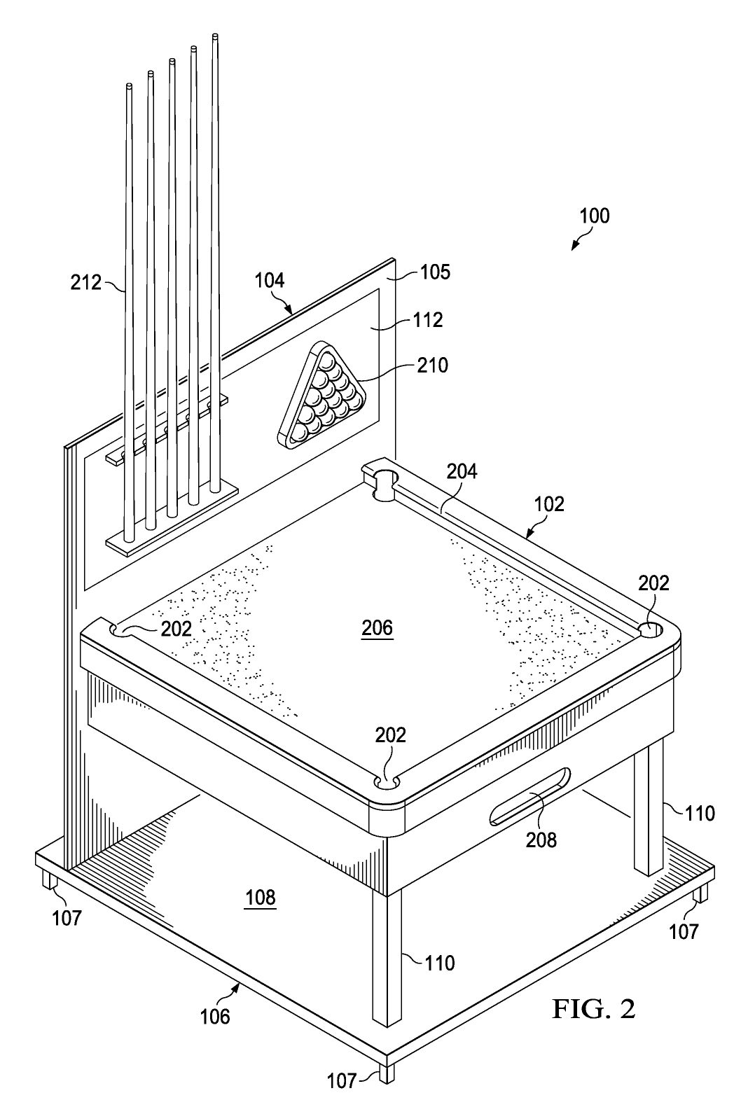

It can be seen with reference to FIG. 1 that the display table 102 comprises a foosball table that has been segmented or cut approximately in half lengthwise. It will be appreciated, though, that the game table 102 need not necessarily be segmented in the exact manner shown. For example, referring now to FIG. 2, a perspective view of another point-of-purchase display system according to aspects of the present disclosure is shown. Here, the display 100 comprises a game table 102 made from a lateral segmentation of a pool table. Whether or not the game table 102 is segmented laterally or transversely, or according to some other section, can be determined based upon the needs of the user or retailer, and the features and functionality to be shown to the potential customer.

In the present example, it can be seen that display device 100 comprises a display device 104 attached to a game table segment 102 and to a base 106. However, since the game table segment 102 is a pool table, different features will be provided for the customer to review. Those include, but are not limited to, a slate surface 206, cushions 204, a ball return 208, a cue ball collection 210, and a cue stick collection 212. As can be seen, some of the samples (cue sticks 212 and game balls 210) will be placed on the display device 104. The features and highlights of the game table 102 combined with the hardware and material samples provided on the display device 104 will allow a customer to see and evaluate a full range of options available for the game table 102 without resorting only to pictures or miniaturized displays.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A display device, comprising
a segment of a functional game table; and
display means attached to the segment for providing information about the segment to a viewer.

2. The display device of claim 1, further comprising a base attached to the segment of a functional game table.

3. The display device of claim 1, wherein the display means comprises a surface providing textual information regarding the game table.

4. The display device of claim 1, wherein the display means comprises a sample of a portion of the game table.

5. The display device of claim 1, wherein the segment of a functional game table comprises a segment of a functional game table taken along a longitudinal axis of the table.

6. The display device of claim 1, wherein the segment of a functional game table comprises a segment of a functional game table taken along a transverse axis of the table.

7. The display device of claim 1, wherein the functional game table is a pool table.

8. The display device of claim 1, wherein the functional game table is a foosball table.

9. The display device of claim 1, wherein the functional game table is a hockey game table.

10. A display device, comprising:
a demonstration structure having at least a portion of an operable gaming device; and
an information structure attached to the demonstration structure, the information structure presenting information to a viewer about the gaming device.

11. The device of claim 10, wherein the portion of an operable gaming device comprises a section of a game table taken along a longitudinal section thereof.

12. The device of claim 10, wherein the portion of an operable gaming device comprises a section of a game table taken along a transverse section axis thereof.

13. The device of claim 12, wherein the demonstration structure provides an operable game table mechanism.

14. The device of claim 10, wherein the operable gaming device is a pool table.

15. The device of claim 10, wherein the operable gaming device is a foosball table.

16. The device of claim 10, wherein the information structure provides material samples.

17. A method of displaying a game table, comprising
providing a fully functional segment of a full sized game table; and
attaching an information display to the segmented game table.

18. The method of claim 17, wherein providing a fully functional segment of a full sized game table comprises providing a lateral segment of a game table with at least one manually manipulable feature.

19. The method of claim 17, wherein attaching an information display to the segmented game table comprises providing information on the display relating to features and construction of the game table.

20. The method of claim 17, further comprising attaching a base to the segment.
